(19) United States
(12) Patent Application Publication
(10) Pub. No.: US 2025/0037217 A1
(43) Pub. Date: Jan. 30, 2025

(54) CONSTRUCTION MANAGEMENT SYSTEM AND CONSTRUCTION MANAGEMENT METHOD

(71) Applicant: Komatsu Ltd., Tokyo (JP)

(72) Inventors: Shun Kawamoto, Tokyo (JP); Tsubasa Hasumi, Tokyo (JP); Shota Hirama, Tokyo (JP)

(73) Assignee: Komatsu Ltd., Tokyo (JP)

(21) Appl. No.: 18/716,206

(22) PCT Filed: Dec. 7, 2022
(86) PCT No.: PCT/JP2022/045053

§ 371 Date: Jun. 4, 2024

(30) Foreign Application Priority Data
Dec. 10, 2021 (JP) 2021-201058

(51) Int. Cl. G06Q 50/08; G06T 7/70; G06T 17/05; G06V 40/10

(52) U.S. Cl. CPC G06Q 50/08; G06T 7/70; G06T 17/05; G06V 40/10; G06T 2207/10032; G06T 2207/20081; G06T 2207/30196; G06T 2207/30252

(57) ABSTRACT

A construction management system includes an image data acquisition unit that acquires image data indicating an image of a construction site where a work machine operates, a terrain data storage unit that stores terrain data indicating a three-dimensional shape of a terrain shape of the construction site, a person specifying unit that specifies a person in the image, a two-dimensional position specifying unit that specifies a two-dimensional position of the person in the image, and a three-dimensional position specifying unit that specifies a three-dimensional position of the person in the construction site based on the two-dimensional position and the terrain data.

### FIELD

The present disclosure relates to a construction management system and a construction management method.

### BACKGROUND

In a technical field relating to a construction management system, a construction management system disclosed in Patent Literature 1 is known.

### CITATION LIST

### Patent Literature

Patent Literature 1: WO 2019/012993 A

### SUMMARY

### Technical Problem

A person is sometimes present in a construction site. In order to suppress deterioration in construction efficiency in the construction site, it is preferable that the position of the person can be checked.

An object of the present disclosure is to check the position of a person in a construction site.

### Solution to Problem

According to an aspect of the present invention, a construction management system comprising: an image data acquisition unit that acquires image data indicating an image of a construction site where a work machine operates; a terrain data storage unit that stores terrain data indicating a three-dimensional shape of a terrain of the construction site; a person specifying unit that specifies a person in the image; a two-dimensional position specifying unit that specifies a two-dimensional position of the person in the image; and a three-dimensional position specifying unit that specifies a three-dimensional position of the person in the construction site based on the two-dimensional position and the terrain data.

### Advantageous Effects of Invention

According to the present disclosure, the position of a person in a construction site can be checked.

### BRIEF DESCRIPTION OF DRAWINGS

FIG. 1 is a schematic diagram illustrating a construction management system according to an embodiment.

FIG. 2 is a diagram illustrating a flight vehicle according to the embodiment.

FIG. 3 is a functional block diagram illustrating the construction management system according to the embodiment.

FIG. 4 is a flowchart illustrating a construction management method according to the embodiment.

FIG. 5 is a diagram illustrating a method of specifying a person according to the embodiment.

FIG. 6 is a diagram illustrating a method of specifying a three-dimensional position of a person according to the embodiment.

FIG. 7 is a diagram illustrating a use form of the three-dimensional position of the person according to the embodiment.

FIG. 8 is a block diagram illustrating a computer system according to the embodiment.

FIG. 9 is a diagram illustrating a method of specifying a three-dimensional position of a person according to another embodiment.

### DESCRIPTION OF EMBODIMENTS

An embodiment according to the present disclosure is explained below with reference to the drawings. However, the present disclosure is not limited to the embodiment. Constituent elements of the embodiment explained below can be combined as appropriate. A part of the constituent elements is sometimes not used.

### [Construction Management System]

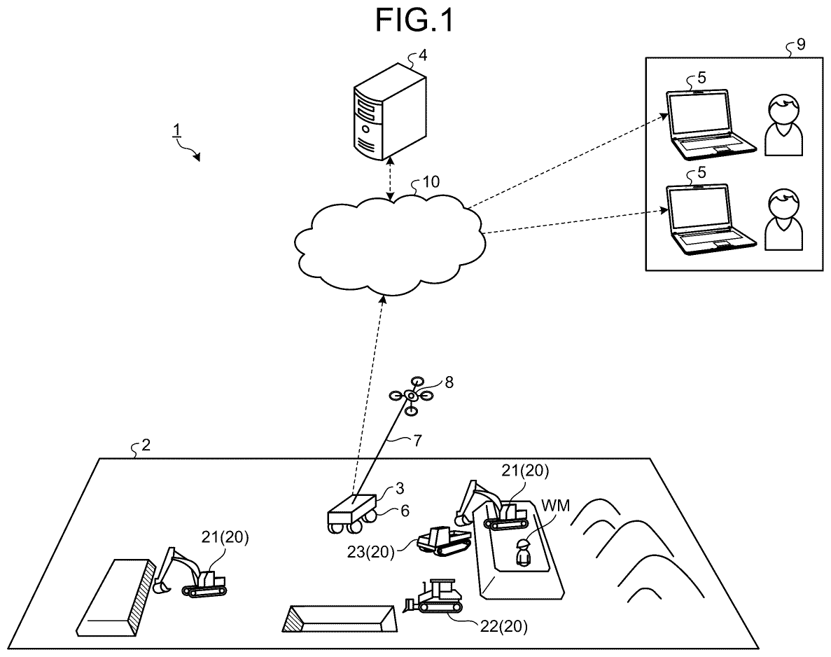

FIG. 1 is a schematic diagram illustrating a construction management system 1 according to an embodiment. The construction management system 1 manages construction in a construction site 2. A plurality of work machines 20 operate in the construction site 2. In the embodiment, the work machine 20 includes an excavator 21, a bulldozer 22, and a crawler dump truck 23. A person WM is present in the construction site 2. Examples of the person WM include a worker who works in the construction site 2. Note that the person WM may be a supervisor who manages construction. The person WM may be a visitor.

As illustrated in FIG. 1, the construction management system 1 includes a management device 3, a server 4, an information terminal 5, and a flight vehicle 8.

The management device 3 includes a computer system disposed in the construction site 2. The management device 3 is supported by a traveling device 6. The management device 3 can travel the construction site 2 with the traveling device 6. Examples of the traveling device 6 include an aerial work vehicle, a truck, and a traveling robot.

The server 4 includes a computer system. The server 4 may be disposed in the construction site 2 or may be disposed in a remote place from the construction site 2.

The information terminal 5 is a computer system disposed in a remote place 9 from the construction site 2. Examples of the information terminal 5 include a personal computer and a smartphone.

The management device 3, the server 4, and the information terminal 5 communicate via a communication system 10. Examples of the communication system 10 include the Internet, a local area network (LAN), a mobile phone communication network, and a satellite communication network.

The flight vehicle 8 flies in the construction site 2. Examples of the flight vehicle 8 include an unmanned aerial vehicle (UAV) such as a drone. In the embodiment, the flight vehicle 8 and the management device 3 are connected by a cable 7. The management device 3 includes a power supply or a generator. The management device 3 can supply electric power to the flight vehicle 8 via the cable 7.

### [Flight Vehicle]

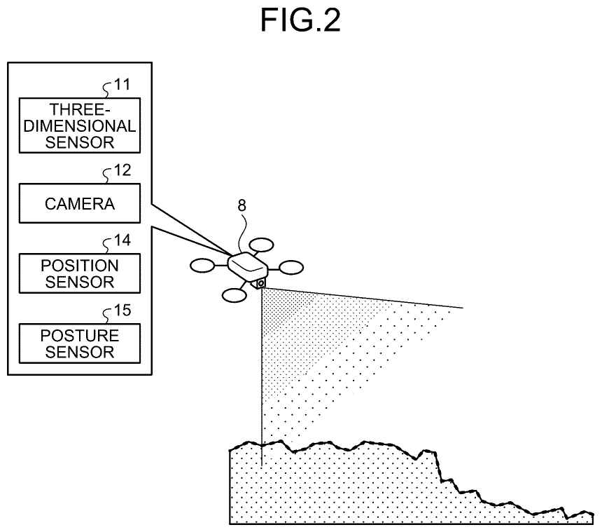

FIG. 2 is a diagram illustrating the flight vehicle 8 according to the embodiment. A three-dimensional sensor 11, a camera 12, a position sensor 14, and a posture sensor 15 are mounted on the flight vehicle 8.

The three-dimensional sensor 11 detects the construction site 2. The three-dimensional sensor 11 acquires three-dimensional data indicating a three-dimensional shape of the terrain of the construction site 2. Detection data of the three-dimensional sensor 11 includes three-dimensional data of the construction site 2. The three-dimensional sensor 11 is disposed in the flight vehicle 8. The three-dimensional sensor 11 detects the construction site 2 from above the construction site 2. Examples of the three-dimensional sensor 11 include a laser sensor (LIDAR: Light Detection and Ranging) that detects a detection target by emitting laser light. Note that the three-dimensional sensor 11 may be an infrared sensor that detects an object by emitting infrared light or a radar sensor (RADAR: Radio Detection and Ranging) that detects an object by emitting radio waves. Note that the three-dimensional sensor 11 may be a three-dimensional camera such as a stereo camera.

The camera 12 images the construction site 2. The camera 12 acquires image data indicating an image of the construction site 2. Imaging data of the camera 12 includes the image data of the construction site 2. The camera 12 is disposed in the flight vehicle 8. The camera 12 images the construction site 2 from above the construction site 2. The camera 12 is a two-dimensional camera such as a monocular camera. The camera 12 may be a visible light camera or an infrared camera. The image data acquired by the camera 12 may be moving image data or still image data. When the three-dimensional sensor 11 is the stereo camera, the stereo camera may be the camera 12.

The position sensor 14 detects the position of the flight vehicle 8. The position sensor 14 detects the position of the flight vehicle 8 using a global navigation satellite system (GNSS). The position sensor 14 includes a GNSS receiver (GNSS sensor) and detects the position of the flight vehicle 8 in a global coordinate system. Each of the three-dimensional sensor 11 and the camera 12 is fixed to the flight vehicle 8. The position sensor 14 can detect the position of the three-dimensional sensor 11 and the position of the camera 12 by detecting the position of the flight vehicle 8. Detection data of the position sensor 14 includes position data of the three-dimensional sensor 11 and position data of the camera 12.

The posture sensor 15 detects a posture of the flight vehicle 8. The posture includes, for example, a roll angle, a pitch angle, and a yaw angle. Examples of the posture sensor 15 include an inertial measurement unit (IMU). Each of the three-dimensional sensor 11 and the camera 12 is fixed to the flight vehicle 8. The posture sensor 15 can detect the posture of the three-dimensional sensor 11 and the posture of the camera 12 by detecting the posture of the flight vehicle 8. Detection data of the posture sensor 15 includes posture data of the three-dimensional sensor 11 and posture data of the camera 12.

Each of the detection data of the three-dimensional sensor 11, the imaging data of the camera 12, the detection data of the position sensor 14, and the detection data of the posture sensor 15 is transmitted to the management device 3 via the cable 7. Each of the detection data of the three-dimensional sensor 11, the imaging data of the camera 12, the detection data of the position sensor 14, and the detection data of the posture sensor 15 received by the management device 3 is transmitted to the server 4 via the communication system 10.

### [Server]

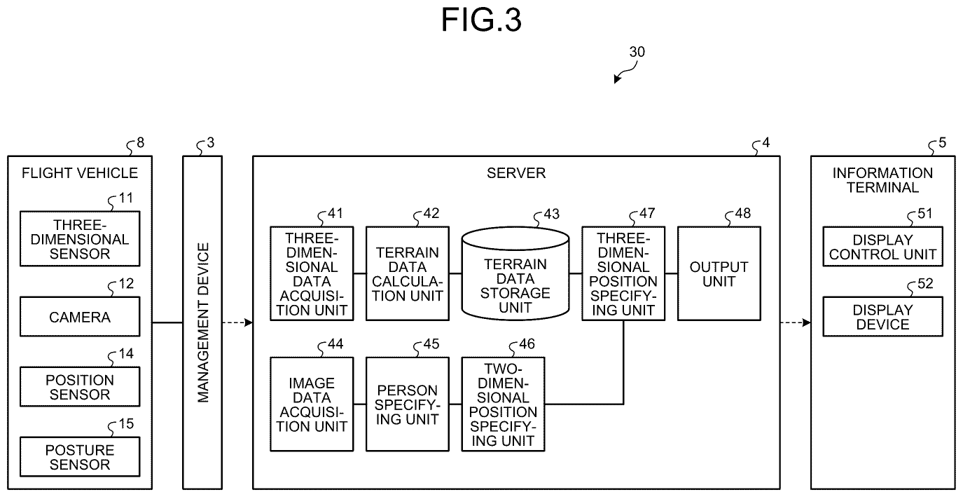

FIG. 3 is a functional block diagram illustrating the construction management system 1 according to the embodiment. As illustrated in FIG. 3, the construction management system 1 includes the flight vehicle 8, the management device 3 disposed in the construction site 2, the server 4, and the information terminal 5 disposed in the remote place 9 from the construction site 2.

The flight vehicle 8 includes the three-dimensional sensor 11, the camera 12, the position sensor 14, and the posture sensor 15.

The information terminal 5 includes a display control unit 51 and a display device 52.

The display device 52 displays display data. An administrator in the remote place 9 can check the display data displayed on the display device 52. Examples of the display device 52 include a flat panel display such as a liquid crystal display (LCD) or an organic electroluminescence display (OELD).

The server 4 includes a three-dimensional data acquisition unit 41, a terrain data calculation unit 42, a terrain data storage unit 43, an image data acquisition unit 44, a person specifying unit 45, a two-dimensional position specifying unit 46, a three-dimensional position specifying unit 47, and an output unit 48.

The three-dimensional data acquisition unit 41 acquires detection data of the three-dimensional sensor 11. That is, the three-dimensional data acquisition unit 41 acquires three-dimensional data of the construction site 2 from the three-dimensional sensor 11.

The terrain data calculation unit 42 calculates terrain data indicating a three-dimensional shape of a terrain of the construction site 2 based on the three-dimensional data of the construction site 2 acquired by the three-dimensional data acquisition unit 41. The terrain data calculation unit 42 acquires, from the position sensor 14, the position of the three-dimensional sensor 11 at the time when the three-dimensional sensor 11 detects the construction site 2 and acquires, from the posture sensor 15, the posture of the three-dimensional sensor 11 at the time when the three-dimensional sensor 11 detects the construction site 2. The three-dimensional data of the construction site 2 includes point cloud data including a plurality of detection points. The three-dimensional data of the construction site 2 includes a relative distance and a relative position between the three-dimensional sensor 11 and each of the plurality of detection points specified in a detection target. The terrain data calculation unit 42 can calculate, for example, terrain data in a local coordinate system specified in the construction site 2 based on the three-dimensional data of the construction site 2 acquired by the three-dimensional data acquisition unit 41, the position of the three-dimensional sensor 11 detected by the position sensor 14, and the posture of the three-dimensional sensor 11 detected by the posture sensor 15.

The terrain data storage unit 43 stores terrain data indicating the three-dimensional shape of the terrain of the construction site 2 calculated by the terrain data calculation unit 42.

The image data acquisition unit 44 acquires imaging data of the camera 12. That is, the image data acquisition unit 44 acquires, from the camera 12, image data indicating an image of the construction site 2. The image acquired from the camera 12 is a two-dimensional image of the construction site 2.

The person specifying unit 45 specifies the person WM in the image of the construction site 2 acquired by the image data acquisition unit 44. The person specifying unit 45 specifies the person WM using artificial intelligence (AI) that analyzes input data with an algorithm and outputs output data. The person specifying unit 45 specifies the person WM using, for example, a neural network.

The two-dimensional position specifying unit 46 specifies a two-dimensional position of the person WM in the image of the construction site 2 acquired by the image data acquisition unit 44.

The three-dimensional position specifying unit 47 specifies a three-dimensional position of the person WM in the construction site 2 based on the two-dimensional position of the person WM in the image of the construction site 2 specified by the two-dimensional position specifying unit 46 and the terrain data of the construction site 2 stored in the terrain data storage unit 43. In the embodiment, the three-dimensional position specifying unit 47 specifies the three-dimensional position of the person WM in the construction site 2 based on the position of the camera 12 detected by the position sensor 14, the two-dimensional position of the person WM in the image of the construction site 2 specified by the two-dimensional position specifying unit 46, and the terrain data of the construction site 2 stored in the terrain data storage unit 43.

The output unit 48 outputs the three-dimensional position of the person WM in the construction site 2 specified by the three-dimensional position specifying unit 47 to the information terminal 5. The output unit 48 transmits the three-dimensional position of the person WM in the construction site 2 to the information terminal 5 via the communication system 10.

The output unit 48 transmits, to the display control unit 51, a control command for causing the display device 52 to display the three-dimensional position of the person WM in the construction site 2. The display control unit 51 controls, based on the control command transmitted from the output unit 48, the display device 52 such that the three-dimensional position of the person WM in the construction site 2 is displayed on the display device 52.

### [Construction Management Method]

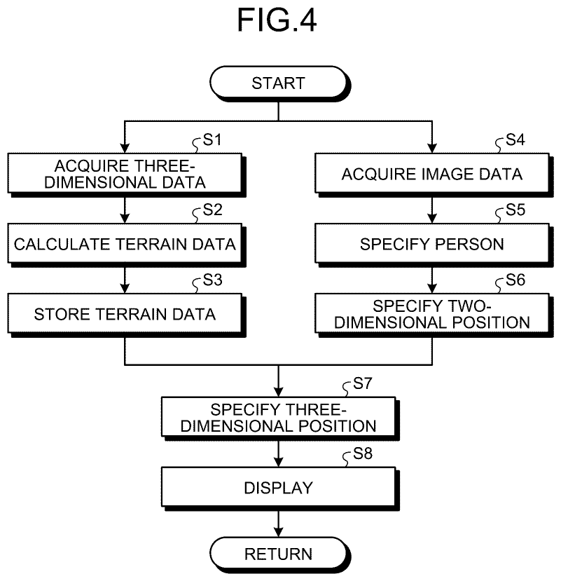

FIG. 4 is a flowchart illustrating a construction management method according to the embodiment. In the embodiment, a detection range of the three-dimensional sensor 11 and at least a part of an imaging range of the camera 12 overlap. Detection processing for the construction site 2 by the three-dimensional sensor 11 and imaging processing for the construction site 2 by the camera 12 are simultaneously carried out. The three-dimensional sensor 11 and the camera 12 are fixed to the flight vehicle 8. Before the detection processing by the three-dimensional sensor 11 and the imaging processing by the camera 12 are carried out, calibration processing of calculating each of relative positions of the three-dimensional sensor 11 and the camera 12 and relative postures of the three-dimensional sensor 11 and the camera 12 is carried out.

When the flight vehicle 8 starts flying above the construction site 2, the detection processing for the construction site 2 by the three-dimensional sensor 11 and the imaging processing for the construction site 2 by the camera 12 are started.

The three-dimensional data acquisition unit 41 acquires three-dimensional data of the construction site 2 from the three-dimensional sensor 11 (Step S1).

The terrain data calculation unit 42 calculates, based on the three-dimensional data of the construction site 2 acquired in Step S1, terrain data indicating a three-dimensional shape of a terrain of the construction site 2 (Step S2).

Based on the three-dimensional data of the construction site 2, the position of the three-dimensional sensor 11 detected by the position sensor 14, and the posture of the three-dimensional sensor 11 detected by the posture sensor 15, the terrain data calculation unit 42 calculates, for example, terrain data in a local coordinate system defined in the construction site 2.

The terrain data storage unit 43 stores the terrain data indicating the three-dimensional shape of the terrain of the construction site 2 calculated in Step S2 (Step S3).

The image data acquisition unit 44 acquires, from the camera 12, image data indicating an image of the construction site 2. The image acquired by the image data acquisition unit 44 is a two-dimensional image of the construction site 2 (Step S4).

The person specifying unit 45 specifies the person WM in the image of the construction site 2 acquired in Step S4. The person specifying unit 45 specifies the person WM using artificial intelligence (AI) (Step S5).

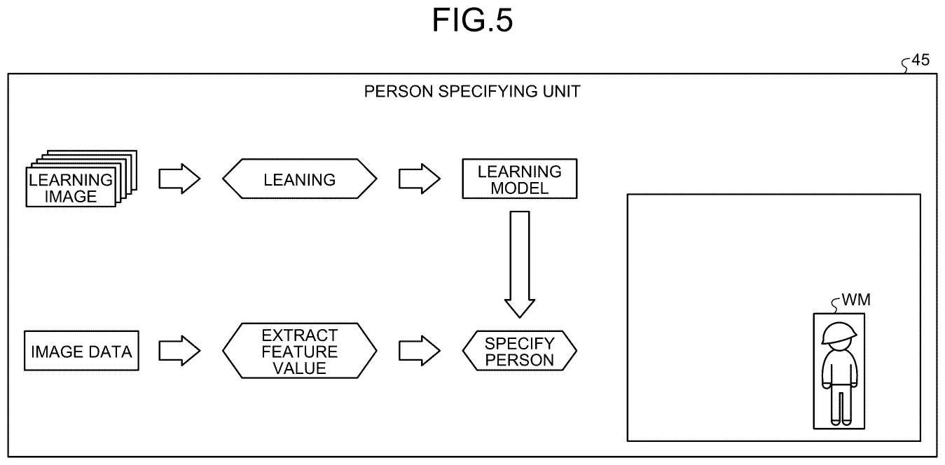

FIG. 5 is a diagram illustrating a method of specifying the person WM according to the embodiment. The person specifying unit 45 retains a learning model generated by learning a feature value of an object. The person specifying unit 45 specifies the person WM from the two-dimensional image based on the learning model. For example, by performing machine learning using, as teacher data, a learning image including an image of a person, the person specifying unit 45 generates a learning model to which the feature value of the object is input and from which the person (presence or absence of the person) is output. The person specifying unit 45 inputs a feature value of the object extracted from the image data indicating the image of the construction site 2 acquired in Step S4 to the learning model and specifies the person WM in the two-dimensional image.

After the person WM is specified in Step S5, the two-dimensional position specifying unit 46 specifies a two-dimensional position of the person WM in the two-dimensional image. In the embodiment, the two-dimensional position specifying unit 46 specifies a two-dimensional position of the feet of the person WM (Step S6).

The three-dimensional position specifying unit 47 specifies a three-dimensional position of the person WM in the construction site 2 based on the two-dimensional position of the person WM in the two-dimensional image of the construction site 2 specified in Step S6 and the terrain data of the construction site 2 stored in the terrain data storage unit 43 (Step S7).

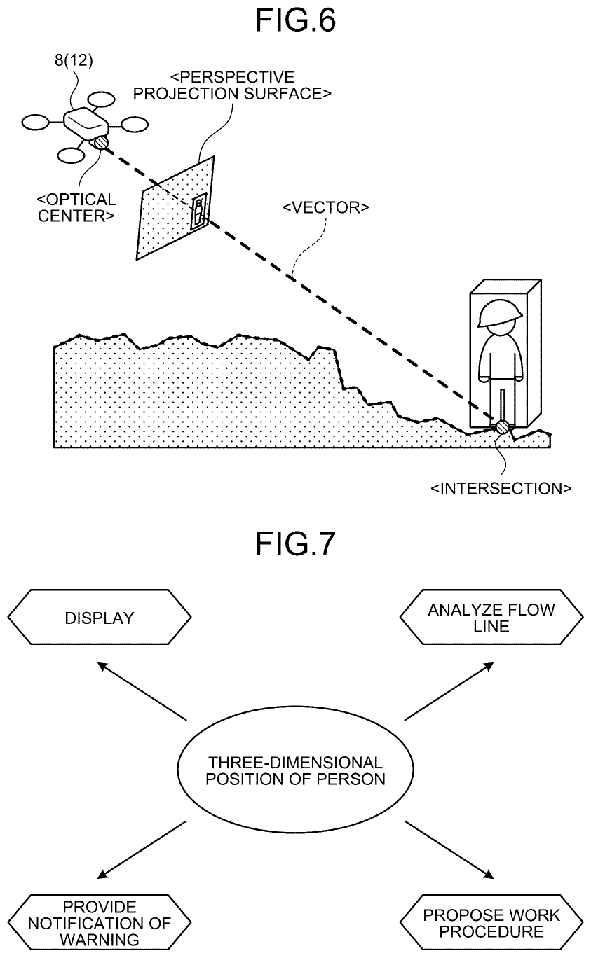

FIG. 6 is a diagram illustrating a method of specifying a three-dimensional position of the person WM according to the embodiment. The three-dimensional position of the person WM is, for example, a three-dimensional position in the terrain data of the construction site 2. As illustrated in FIG. 6, a perspective projection surface is defined between the optical center of the camera 12 and the person WM. By the calibration processing explained above, each of the relative positions of the three-dimensional sensor 11 and the camera 12 and the relative postures of the three-dimensional sensor 11 and the camera 12 are known. The perspective projection surface is an image plane virtually defined based on a perspective projection model. The three-dimensional position specifying unit 47 specifies the three-dimensional position of the person WM in the construction site 2 based on an intersection between a vector connecting the optical center of the camera 12 and the person WM on the perspective projection surface and the terrain. The terrain data of the construction site 2 includes point cloud data including a plurality of detection points. The three-dimensional position specifying unit 47 specifies, from the plurality of detection points, as the three-dimensional position of the person WM, a detection point having the largest inner product with the vector. The vector is set to pass the feet of the person WM on the perspective projection surface. The three-dimensional position specifying unit 47 specifies a three-dimensional position of the feet of the person WM as the three-dimensional position of the person WM.

The output unit 48 transmits the three-dimensional position of the person WM specified in Step S7 to the information terminal 5 via the communication system 10. The output unit 48 transmits, to the display control unit 51, a control command for causing the display device 52 to display the three-dimensional position of the person WM in the construction site 2. The display control unit 51 causes the display device 52 to display the three-dimensional position of the person WM in the construction site 2 based on the control command transmitted from the output unit 48 (Step S8).

### [Use Form of the Three-Dimensional Position of the Person]

FIG. 7 is a diagram illustrating a use form of the three-dimensional position of the person WM according to the embodiment. The information terminal 5 can recognize a situation of the construction site 2 based on the three-dimensional position of the person WM. The information terminal 5 can analyze a flow line of the worker based on the three-dimensional position of the person WM and achieve, for example, improvement of work efficiency The information terminal 5 can propose a work procedure with high work efficiency based on the three-dimensional position of the person WM. The information terminal 5 can notify the person WM of a warning based on the three-dimensional position of the person WM. The information terminal 5 can notify, based on the three-dimensional position of the person WM, an information terminal carried by the worker of the warning such that, for example, safety of the worker is secured.

### [Computer System]

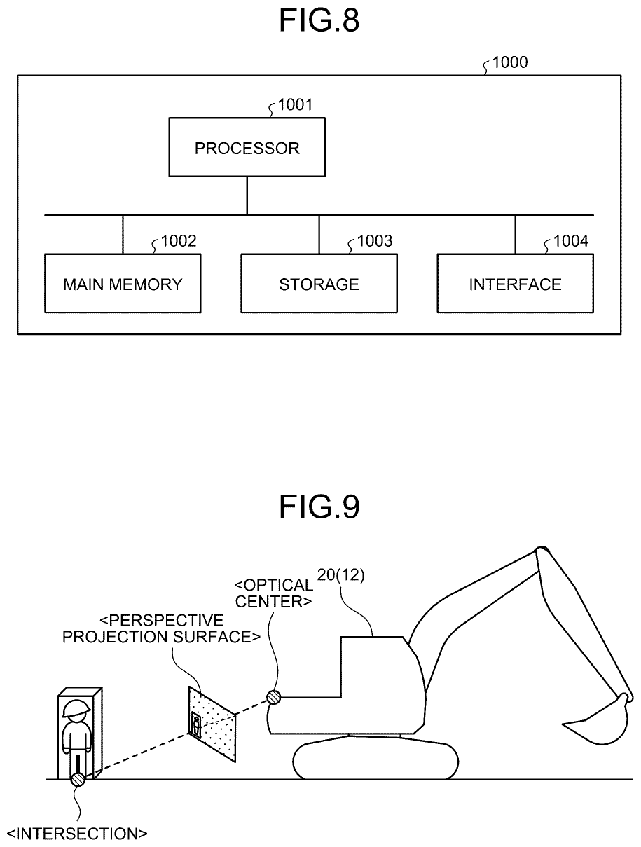

FIG. 8 is a block diagram illustrating a computer system 1000 according to the embodiment. The server 4 explained above includes the computer system 1000. The computer system 1000 includes a processor 1001 such as a CPU (Central Processing Unit), a main memory 1002 including a nonvolatile memory such as a ROM (Read Only Memory) and a volatile memory such as a RAM (Random Access Memory), a storage 1003, and an interface 1004 including an input and output circuit. The functions of the server 4 explained above are stored in the storage 1003 as a computer program. The processor 1001 reads the computer program from the storage 1003, loads the computer program in the main memory 1002, and executes the processing explained above according to the program. Note that the computer program may be distributed to the computer system 1000 via a network.

The computer program or the computer system 1000 can execute acquiring image data indicating an image of the construction site 2 where the work machine 20 operates, storing terrain data indicating a three-dimensional shape of a terrain of the construction site 2, specifying the person WM in the image, specifying a two-dimensional position of the person WM in the image, and specifying a three-dimensional position of the person WM in the construction site 2 based on the two-dimensional position and the terrain data, according to the embodiment explained above.

### [Effects]

As explained above, according to the embodiment, the server 4 can specify the three-dimensional position of the person WM in the construction site 2. Accordingly, for example, the administrator can check the three-dimensional position of the person WM in the construction site 2.

There is possibility that it is difficult to specify the person WM only from the detection data of the three-dimensional sensor 11. It is possible to highly accurately specify the person WM from the two-dimensional image acquired by the camera 12. In the embodiment, the three-dimensional position of the person WM is highly accurately specified by combining the terrain of the construction site 2 calculated from the detection data of the three-dimensional sensor 11 and the two-dimensional position of the person WM specified from the imaging data of the camera 12.

The three-dimensional position specifying unit 47 can specify the three-dimensional position of the person WM based on the position of the camera 12 detected by the position sensor 14, the two-dimensional position of the person WM in the two-dimensional image, and the terrain data of the construction site 2.

Since the perspective projection surface is defined, the three-dimensional position specifying unit 47 can specify the three-dimensional position of the person WM based on the intersection between the terrain and the vector connecting the optical center of the camera 12 and the person WM on the perspective projection surface.

Since the position of the feet of the person WM is specified, a relation between the person WM and the terrain is highly accurately specified.

Since the camera 12 is disposed in the flight vehicle 8, which is a moving body, the construction site 2 is imaged over a wide range. Since the three-dimensional sensor 11 is disposed in the flight vehicle 8, which is the moving body, the terrain of the construction site 2 is detected over a wide range.

The person specifying unit 45 can highly accurately specify the person WM from the two-dimensional image using artificial intelligence.

Since the specified three-dimensional position of the person WM is displayed on the display device 52, as explained with reference to FIG. 7, it is possible to suppress deterioration in work efficiency and deterioration in a work environment of the construction site 2.

### Other Embodiments

In the embodiment explained above, the flight vehicle 8 is a wired flight vehicle connected to the cable 7. The flight vehicle 8 may be a wireless flight vehicle not connected to cable 7.

In the embodiment explained above, the two-dimensional position specifying unit 46 specifies the two-dimensional position of the feet of the person WM. The two-dimensional position specifying unit 46 may specify a two-dimensional position of the head of the person WM, may specify a two-dimensional position of any region of the person WM, or may specify a two-dimensional position of an article worn on the person WM.

In the embodiment explained above, the position sensor 14 is used to detect the position of the flight vehicle 8 and the posture sensor 15 is used to detect the posture of the flight vehicle 8. The position and the posture of the flight vehicle 8 may be detected using SLAM (Simultaneous Localization and Mapping). The position and posture of the flight vehicle 8 may be detected using terrestrial magnetism or a barometer.

In the embodiment explained above, the person specifying unit 45 may specify the person WM based on, for example, a pattern matching method without using artificial intelligence. The person specifying unit 45 can specify the person WM by collating a template indicating the person WM and the image data of the construction site 2. The person specifying unit 45 may specify the person WM based on heat quantity of the person WM detected by the infrared camera.

In the embodiment explained above, the management device 3 is supported by the traveling device 6 and can travel in the construction site 2. The management device 3 may be mounted on the work machine 20 or may be installed at a predetermined position in the construction site 2.

In the embodiment explained above, the information terminal 5 may not be disposed in the remote place 9 from the construction site 2. The information terminal 5 may be mounted on, for example, the work machine 20.

In the embodiment explained above, the function of the server 4 may be provided in the management device 3, may be provided in the information terminal 5, or may be provided in the computer system mounted on the flight vehicle 8. For example, the function of at least one of the three-dimensional data acquisition unit 41, the terrain data calculation unit 42, the terrain data storage unit 43, the image data acquisition unit 44, the person specifying unit 45, the two-dimensional position specifying unit 46, the three-dimensional position specifying unit 47, and the output unit 48 may be provided in the management device 3, may be provided in the information terminal 5, or may be provided in the computer system mounted on the flight vehicle 8.

In the embodiment explained above, each of the three-dimensional data acquisition unit 41, the terrain data calculation unit 42, the terrain data storage unit 43, the image data acquisition unit 44, the person specifying unit 45, the two-dimensional position specifying unit 46, the three-dimensional position specifying unit 47, and the output unit 48 may be configured by different kinds of hardware.

In the embodiment explained above, at least one of the three-dimensional sensor 11 and the camera 12 may not be disposed in the flight vehicle 8. At least one of the three-dimensional sensor 11 and the camera 12 may be disposed in, for example, the work machine 20.

FIG. 9 is a diagram illustrating a method of specifying a three-dimensional position of the person WM according to another embodiment. As illustrated in FIG. 9, the camera 12 is mounted on the work machine 20. The three-dimensional position specifying unit 47 may specify a three-dimensional position of the person WM in the construction site 2 based on an intersection between a vector connecting the optical center of the camera 12 mounted on the work machine 20 and the person WM on the perspective projection surface and a terrain.

At least one of the three-dimensional sensor 11 and the camera 12 may be disposed in a moving body different from the flight vehicle 8 and the work machine 20. At least one of the three-dimensional sensor 11 and the camera 12 may be disposed in a structure present in the construction site 2. A plurality of three-dimensional sensors 11 may be installed in the construction site 2. The terrain of the construction site 2 may be detected over a wide range. A plurality of cameras 12 may be installed in the construction site 2. The construction site 2 may be imaged over a wide range.

In the embodiment explained above, the detection processing by the three-dimensional sensor 11 and the imaging processing by the camera 12 are simultaneously carried out. After the detection processing by the three-dimensional sensor 11 is carried out and the terrain data of the construction site 2 is stored in the terrain data storage unit 43, the imaging processing for the construction site 2 by the camera 12 may be carried out. The position and the posture of the three-dimensional sensor 11 at the time when the construction site 2 is detected are detected and the position and the posture of the camera 12 at the time when the construction site 2 is imaged are detected, whereby the three-dimensional position specifying unit 47 can specify the three-dimensional position of the person WM in the construction site 2 based on the two-dimensional position of the person WM and the terrain data.

In the embodiment explained above, the work machine 20 may be a work machine different from the excavator 21, the bulldozer 22, and the crawler dump truck 23. The work machine 20 may include, for example, a wheel loader.

### REFERENCE SINGS LIST

1 CONSTRUCTION MANAGEMENT SYSTEM
2 CONSTRUCTION SITE
3 MANAGEMENT DEVICE
4 SERVER (DATA PROCESSING DEVICE)
5 INFORMATION TERMINAL
6 TRAVELING DEVICE
7 CABLE
8 FLIGHT VEHICLE
9 REMOTE PLACE
10 COMMUNICATION SYSTEM
11 THREE-DIMENSIONAL SENSOR
12 CAMERA
14 POSITION SENSOR
15 POSTURE SENSOR
20 WORK MACHINE
21 EXCAVATOR
22 BULLDOZER
23 CRAWLER DUMP TRUCK
41 THREE-DIMENSIONAL DATA ACQUISITION UNIT
42 TERRAIN DATA CALCULATION UNIT
43 TERRAIN DATA STORAGE UNIT
44 IMAGE DATA ACQUISITION UNIT
45 PERSON SPECIFYING UNIT
46 TWO-DIMENSIONAL POSITION SPECIFYING UNIT
47 THREE-DIMENSIONAL POSITION SPECIFYING UNIT
48 OUTPUT UNIT
51 DISPLAY CONTROL UNIT
52 DISPLAY DEVICE
1000 COMPUTER SYSTEM
1001 PROCESSOR
1002 MAIN MEMORY
1003 STORAGE
1004 INTERFACE
WM PERSON.

1. A construction management system comprising:
an image data acquisition unit that acquires image data indicating an image of a construction site where a work machine operates;
a terrain data storage unit that stores terrain data indicating a three-dimensional shape of a terrain of the construction site;
a person specifying unit that specifies a person in the image;
a two-dimensional position specifying unit that specifies a two-dimensional position of the person in the image; and
a three-dimensional position specifying unit that specifies a three-dimensional position of the person in the construction site based on the two-dimensional position and the terrain data.

2. The construction management system according to claim 1, wherein
the image data acquisition unit acquires image data from a camera that images the construction site, and
the three-dimensional position specifying unit specifies the three-dimensional position based on a position of the camera, the two-dimensional position, and the terrain data.

3. The construction management system according to claim 2, wherein
a perspective projection surface is defined between an optical center of the camera and the person, and
the three-dimensional position specifying unit specifies the three-dimensional position based on an intersection between a vector connecting the optical center and the person on the perspective projection surface and the terrain.

4. The construction management system according to claim 3, wherein
the vector is set to pass a region of the person on the perspective projection surface.

5. The construction management system according to claim 4, wherein
the region of the person is feet of the person.

6. The construction management system according to claim 2, wherein
the camera is disposed in a moving body.

7. The construction management system according to claim 6, wherein
the moving body includes at least one of a flight vehicle and the work machine.

8. The construction management system according to claim 1, wherein the person specifying unit specifies the person based on a learning model to which a feature value of an object is input and from which the person is output.

9. The construction management system according to claim 1, comprising
a display control unit that causes a display device to display the three-dimensional position.

10. A construction management method comprising:
acquiring image data indicating an image of a construction site where a work machine operates;
storing terrain data indicating a three-dimensional shape of a terrain of the construction site;
specifying a person in the image;
specifying a two-dimensional position of the person in the image; and
specifying a three-dimensional position of the person in the construction site based on the two-dimensional position and the terrain data.

11. The construction management method according to claim 10, wherein
the image data is acquired from a camera that images the construction site, and
the three-dimensional position is specified based on a position of the camera, the two-dimensional position, and the terrain data.

12. The construction management method according to claim 11, wherein
a perspective projection surface is defined between an optical center of the camera and the person, and
the three-dimensional position is specified based on an intersection between a vector connecting the optical center and the person on the perspective projection surface and the terrain.

13. The construction management method according to claim 12, wherein
the vector is set to pass a region of the person on the perspective projection surface.

14. The construction management method according to claim 13, wherein
the region of the person is feet of the person.

15. The construction management method according to claim 11, wherein
the camera is disposed in a moving body.

16. The construction management method according to claim 15, wherein
the moving body includes at least one of a flight vehicle and the work machine.

17. The construction management method according to claim 10, wherein
the person is specified based on a learning model to which a feature value of an object is input and from which the person is output.

18. The construction management method according to claim 10, comprising
causing a display device to display the three-dimensional position.
